(19) United States
(12) Patent Application Publication
(10) Pub. No.: US 2026/0063234 A1
(43) Pub. Date: Mar. 5, 2026

(54) Hose Drainer Device

(71) Applicant: Forrest Willis, Owensboro, KY (US)

(72) Inventor: Forrest Willis, Owensboro, KY (US)

(21) Appl. No.: 19/199,557

(22) Filed: May 6, 2025

Related U.S. Application Data
(60) Provisional application No. 63/688,533, filed on Aug. 29, 2024.

(51) Int. Cl. F16L 55/07

(52) U.S. Cl. CPC F16L 55/07

(57) ABSTRACT

A hose drainer device is disclosed, which helps a user safely drain petroleum, oil, antifreeze, and other products from the hose. The hose drainer device comprises a top plate component with a notch in it and a lock to retain the hose being drained. The top plate component is supported by a base component and a pair of upright leg components. A user would then place a container underneath the top plate component and beneath the hose. The hose could then be flushed from the other side, and the container disposed of properly when finished. The device is intended to accommodate a 2″ hose.

### CROSS-REFERENCE TO RELATED APPLICATION

The present application claims priority to, and the benefit of, U.S. Provisional Application No. 63/688,533, which was filed on Aug. 29, 2024, and is incorporated herein by reference in its entirety.

### FIELD OF THE INVENTION

The present invention relates generally to the field of hose drainer devices. More specifically, the present invention relates to a maintenance tool for hoses that helps drain excess petroleum or other material from the hose. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in hose drainer devices. Generally, draining large diameter hoses can be a dangerous and messy job. Typically, the hoses need to be drained between applications to eliminate contamination of fluids, but the hoses are heavy and cumbersome to manipulate. Accordingly, the hose could get contaminated if not drained properly.

Further, people could get hurt trying to drain a hose full of fluid products, such as petroleum, antifreeze, oil, and other suitable products from the hose. In addition, draining the hoses into a bucket often leads to spills and potentially HAZMAT situations, based on the fluid products within the hose.

Accordingly, there is a demand for an improved hose drainer device that provides a maintenance tool for hoses that helps drain excess petroleum or other material from the hose. More particularly, there is a demand for a hose drainer device that offers a way to drain oil, antifreeze, and other petroleum products from hoses in a safe and clean fashion.

Therefore, there exists a long felt need in the art for a hose drainer device that provides users with a maintenance tool for hoses that helps drain excess petroleum or other material from the hose. There is also a long felt need in the art for a hose drainer device that ensures the hose can be flushed of all material to prevent accidental spills and messes. Further, there is a long felt need in the art for a hose drainer device that features a frame with a top plate and locking feature that holds the hose in place, allowing users to flush it into a storage container. Moreover, there is a long felt need in the art for a device that offers a way to drain oil, antifreeze, and other petroleum products from hoses in a safe and clean fashion. Further, there is a long felt need in the art for a hose drainer device that is designed to accommodate a 2″ hose. Finally, there is a long felt need in the art for a hose drainer device that includes a lock to hold the hose in place during use.

The subject matter disclosed and claimed herein, in one embodiment thereof, comprises a hose drainer device. The device helps a user safely drain petroleum, oil, antifreeze, and other products from the hose. The hose drainer device comprises a top plate component with a notch in it and a lock to retain the hose being drained. The top plate component is supported by a base component and a pair of upright leg components. A user would then place a container underneath the top plate component and beneath the hose. The hose could then be flushed from the other side, and the container disposed of properly when finished. The device is intended to accommodate a 2″ hose.

In this manner, the hose drainer device of the present invention accomplishes all of the forgoing objectives and provides users with a device that helps drain excess petroleum or other material from the hose. The device offers a way to drain fluids from hoses in a safe and clean fashion.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a hose drainer device. The hose drainer device comprises a top plate component with a notch through-hole in it and a lock component to retain the hose being drained. The top plate component is supported by a base component and a pair of upright leg components. A user would then place a container underneath the device to flush the hose into the container opening. The container can be properly disposed of when finished.

In one embodiment, the hose drainer device provides users with a maintenance tool for hoses that helps drain excess fluid or other material from the hose. The device ensures the hose can be flushed of all material and fluids to prevent accidental spills and messes. Thus, the hose drainer device offers a way to drain oil, antifreeze, and other petroleum products from hoses in a safe and clean fashion.

In one embodiment, the hose drainer device is utilized with a conventional hose. The hose is a multipurpose hose and can be used for farming and/or agriculture operations, especially if people are using chemicals that could be hazardous to themselves or the environment. Typically, the hose drainer device can safely drain hoses of petroleum, antifreeze, and other suitable fluids. The device is dimensioned to accept 2″ diameter hoses but can be sized and shaped to accommodate hoses of other dimensions, as well.

In one embodiment, the hose drainer device comprises a top plate component. Typically, the top plate component can be configured in a rectangular shape, but can be configured in any suitable shape as is known in the art. The top plate component can be available in a variety of sizes depending on the needs and/or wants of a user. In one embodiment, the top plate component is approximately 2″×6″×18″ in dimension, but other suitable sizes and dimensions can be utilized as is known in the art. The top plate component comprises a top surface, a bottom surface, opposing side walls, and opposing front and back walls.

In one embodiment, the top plate component secures the hose to be drained in place. Specifically, the top plate component comprises a notched through-hole. Typically, the notched through-hole is positioned in the center of the top plate component. The notched through-hole is usually configured in a rectangular or square configuration, but can be any suitable shape as is known in the art. In one embodiment, the notched through-hole is approximately 2″ wide and 2″ deep to accommodate a 2″ diameter hose for draining. However, the notched through-hole can be any suitable size to accommodate hoses of differing diameter, depending on the needs and/or wants of a user.

In one embodiment, the top plate component also comprises a lock component. The lock component is typically a metal plate approximately 1/16″ thick, 1½″ wide, and 8″ long, however any other suitable locking means can be used as is known in the art. The metal plate is positioned flat across the top of the notched through-hole on the top surface of the top plate component and is secured down by a first screw or other suitable means on one end to hold the lock component (i.e., metal plate) in place. The other end of the lock component (i.e., metal plate) comprises a notched end. A second screw is then positioned on the opposing side of the notched through-hole in the top plate component, such that the lock component (i.e., metal plate) swivels back and forth around the first screw, until the notched end meets with the second screw. Thus, the second screw accepts the notched end, securing the lock component (i.e., metal plate) in place.

In one embodiment, the top plate component is supported by a pair of upright leg components. The pair of upright leg components can be any suitable size, but typically are approximately 2″×4×12″ in dimension. The leg components each comprise an interior surface, an exterior surface, opposing top and bottom sides, and opposing sidewalls. The leg components are typically configured in a rectangular configuration and secured to the opposing sidewalls of the top plate component, positioning the top plate component between the interior surface of the leg components, such that they are in an orthogonal orientation to each other. Typically, the interior surface of the leg components is screwed into the wood sidewalls of the top plate component but can be secured via any suitable securing means as is known in the art.

In one embodiment, the pair of upright leg components are secured to a base component to support the device for use. The base component is a pair of wooden boards each configured in a rectangular shape. Each base component measures approximately 2″×8″×18″. The base components each comprises a top surface, a bottom surface, opposing sidewalls, and opposing front and back walls. Once in position, the base components are approximately 12″ apart. The base components are laid flat on their bottom surfaces, and an upright leg component is screwed into the top surface of each base component, such that they are in an orthogonal orientation to each other. Typically, the top surface of the base components are screwed into the bottom sides of the upright leg components but can be secured via any suitable securing means as is known in the art.

In one embodiment, in use the hose drainer device is positioned on a container lid of a container used to retain the liquid and other materials flushed from the hose. Typically, the hose drainer device is placed on the container lid and one end of a hose is inserted into the notched through-hole and secured by the lock component to retain the hose in place within the device. The hose end is then inserted into the pour spout or other through-hole within the container lid. Once in place, the hose can then be flushed from the other end of the hose, with the contents of the hose being released into the container safely and easily, without spills and/or messes. The hose is removed and the pour spout is then sealed, and the container can be disposed of properly when finished. In another embodiment, the hose drainer device can be releasably secured to the container lid via a clamp positioned on each base component, or the hose drainer device can be secured via screws, nuts and bolts, straps, etc.

In one embodiment, the hose drainer device is manufactured from wood, titanium, aluminum, steel, plastic, fiber-reinforced plastic, or other suitable materials as is known in the art, or a combination of such materials.

In yet another embodiment, the hose drainer device comprises a plurality of indicia.

In yet another embodiment, a method of safely draining fluids from a hose is disclosed. The method includes the steps of providing a hose drainer device comprising a top plate component supported by a base component and a pair of upright leg components. The method also comprises inserting a hose into a notch of the top plate component. Further, the method comprises securing the hose within the notch via the lock component. The method also comprises placing a container underneath the top plate component and beneath the hose. Finally, the method comprises draining the hose into the container and disposing of the contents properly when finished.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the hose drainer device of the present invention in accordance with the disclosed architecture;

FIG. 2 illustrates a perspective view of one embodiment of the hose drainer device of the present invention showing the top plate component in accordance with the disclosed architecture;

FIG. 3 illustrates a perspective view of one embodiment of the hose drainer device of the present invention showing the hose lock in accordance with the disclosed architecture;

FIG. 4 illustrates a perspective view of one embodiment of the hose drainer device of the present invention showing the pairs of leg components and base component supporting the top plate component in accordance with the disclosed architecture; and FIG. 5 illustrates a flowchart showing the method of safely draining fluids from a hose in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a hose drainer device that provides users with a maintenance tool for hoses that helps drain excess petroleum or other material from the hose. There is also a long felt need in the art for a hose drainer device that ensures the hose can be flushed of all material to prevent accidental spills and messes. Further, there is a long felt need in the art for a hose drainer device that features a frame with a top plate and locking feature that holds the hose in place, allowing users to flush it into a storage container. Moreover, there is a long felt need in the art for a device that offers a way to drain oil, antifreeze, and other petroleum products from hoses in a safe and clean fashion. Further, there is a long felt need in the art for a hose drainer device that is designed to accommodate a 2″ hose. Finally, there is a long felt need in the art for a hose drainer device that includes a lock to hold the hose in place during use.

The present invention, in one exemplary embodiment, is a novel hose drainer device. The device helps a user safely drain petroleum, oil, antifreeze, and other products from the hose. The hose drainer device comprises a top plate component with a notch in it and a lock to retain the hose being drained. The top plate component is supported by a base component and a pair of upright leg components. A user would then place a container underneath the top plate component and beneath the hose. The hose could then be flushed from the other side, and the container disposed of properly when finished. The device is intended to accommodate a 2″ hose. The present invention also includes a novel method of safely draining fluids from a hose. The method includes the steps of providing a hose drainer device comprising a top plate component supported by a base component and a pair of upright leg components. The method also comprises inserting a hose into a notch of the top plate component. Further, the method comprises securing the hose within the notch via the lock component. The method also comprises placing a container underneath the top plate component and beneath the hose. Finally, the method comprises draining the hose into the container and disposing of the contents properly when finished.

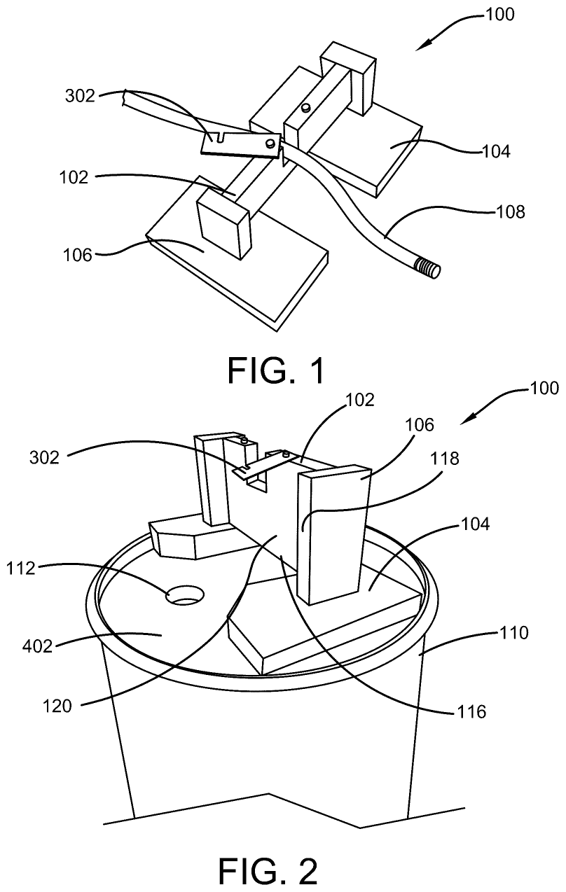

Referring initially to the drawings, FIG. 1 illustrates a perspective view of one embodiment of the hose drainer device 100 of the present invention. In the present embodiment, the hose drainer device 100 is an improved hose drainer device 100 that provides a user with a means for safely draining hoses 108. Specifically, the hose drainer device 100 comprises a top plate component 102 supported by a base component 104 and a pair of upright leg components 106. A user would insert a hose 108 to be drained into the top plate component 102 and then would place a container 110 underneath the device 100 to flush the hose 108 into the container opening 112. The container 110 can be properly disposed of when finished.

Generally, the hose drainer device 100 provides users with a maintenance tool for hoses 108 that helps drain excess fluid or other material from the hose 108. The device 100 ensures the hose 108 can be flushed of all material and fluids to prevent accidental spills and messes. Thus, the hose drainer device 100 offers a way to drain oil, antifreeze, and other petroleum products from hoses 108 in a safe and clean fashion.

Further, the hose drainer device 100 is utilized with a conventional hose 108. The hose 108 is a multipurpose hose and can be used for farming and/or agriculture operations, especially if people are using chemicals that could be hazardous to themselves or the environment. Typically, the hose drainer device 100 can safely drain hoses 108 of petroleum, antifreeze, and other suitable fluids. The device 100 is dimensioned to accept 2″ diameter hoses but can be sized and shaped to accommodate hoses 108 of other dimensions, as well.

Additionally, the hose drainer device 100 comprises a top plate component 102. Typically, the top plate component 102 can be configured in a rectangular shape, but can be configured in any suitable shape as is known in the art. The top plate component 102 can be available in a variety of sizes depending on the needs and/or wants of a user. In one embodiment, the top plate component 102 is approximately 2″×6″×18″ in dimension, but other suitable sizes and dimensions can be utilized as is known in the art. The top plate component 102 comprises a top surface 114, a bottom surface 116, opposing side walls 118, and opposing front and back walls 120.

As shown in FIG. 2, the top plate component 102 is supported by a pair of upright leg components 106. The pair of upright leg components 106 can be any suitable size, but typically are approximately 2″×4″×12″ in dimension. The leg components 106 each comprise an interior surface 200, an exterior surface 202, opposing top and bottom sides 204, and opposing sidewalls 206. The leg components 106 are typically configured in a rectangular configuration and secured to the opposing sidewalls 118 of the top plate component 102, positioning the top plate component 102 between the interior surface 200 of the leg components 106, such that they are in an orthogonal orientation to each other. Typically, the interior surface 200 of the leg components 106 is screwed into the wood sidewalls 118 of the top plate component 102 but can be secured via any suitable securing means as is known in the art.

Further, the pair of upright leg components 106 are secured to a base component 104 to support the device 100 for use. The base component 104 is a pair of wooden boards each configured in a rectangular shape. Each base component 104 measures approximately 2″×8″×18″. The base components 104 each comprises a top surface 208, a bottom surface 210, opposing sidewalls 212, and opposing front and back walls 214. Once in position, the base components 104 are approximately 12″ apart. The base components 104 are laid flat on their bottom surfaces 210, and an upright leg component 106 is screwed into the top surface 208 of each base component 104, such that they are in an orthogonal orientation to each other. Typically, the top surface 208 of the base components 104 are screwed into the bottom sides 204 of the upright leg components 106 but can be secured via any suitable securing means as is known in the art.

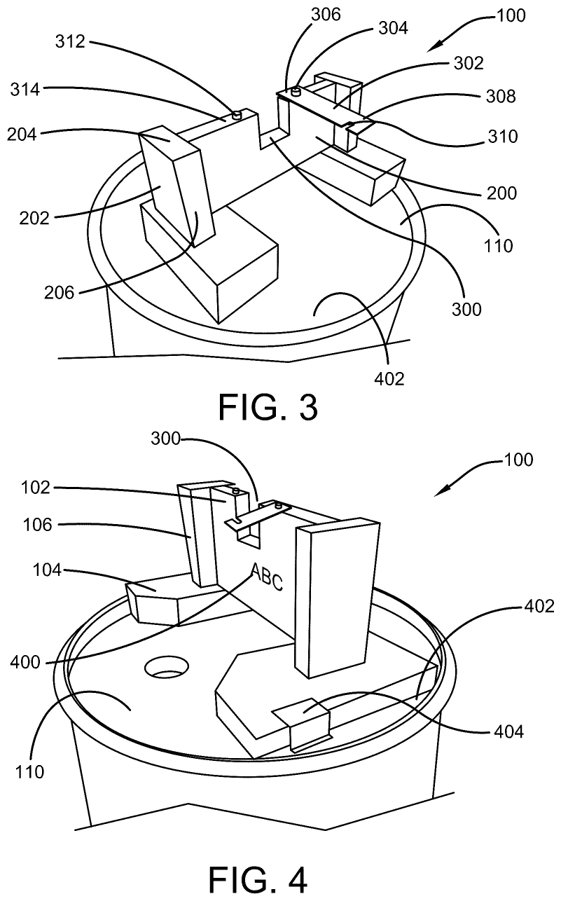

As shown in FIG. 3, the top plate component 102 secures the hose 108 to be drained in place. Specifically, the top plate component 102 comprises a notched through-hole 300. Typically, the notched through-hole 300 is positioned in the center of the top plate component 102. The notched through-hole 300 is usually configured in a rectangular or square configuration, but can be any suitable shape as is known in the art. In one embodiment, the notched through-hole 300 is approximately 2″ wide and 2″ deep to accommodate a 2″ diameter hose 108 for draining. However, the notched through-hole 300 can be any suitable size to accommodate hoses 108 of differing diameter, depending on the needs and/or wants of a user.

Further, the top plate component 102 also comprises a lock component 302. The lock component 302 is typically a metal plate approximately 1/16″ thick, 1½″ wide, and 8″ long, however any other suitable locking means can be used as is known in the art. The metal plate 302 is positioned flat across the top of the notched through-hole 300 on the top surface 114 of the top plate component 102 and is secured down by a first screw 304 or other suitable means on one end 306 to hold the lock component 302 (i.e., metal plate) in place. The other end 308 of the lock component 302 (i.e., metal plate) comprises a notched end 310. A second screw 312 is then positioned on the opposing side 314 of the notched through-hole 300 in the top plate component 102, such that the lock component 302 (i.e., metal plate) swivels back and forth around the first screw 304, until the notched end 310 meets with the second screw 312. Thus, the second screw 312 accepts the notched end 310, securing the lock component 302 (i.e., metal plate) in place.

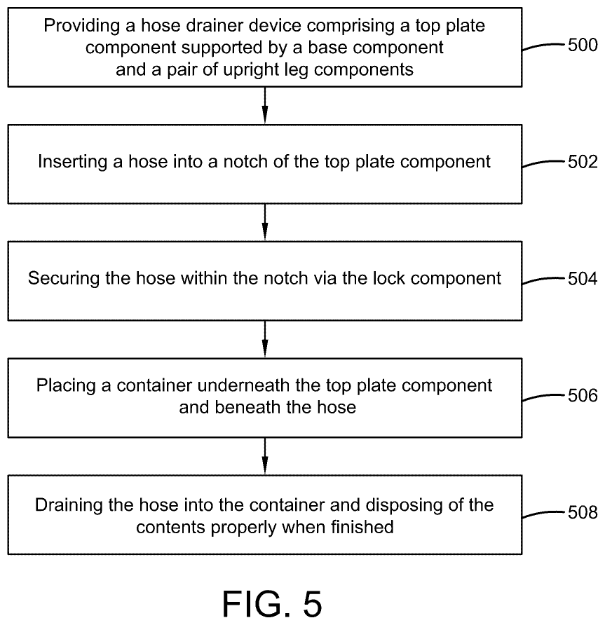

As shown in FIG. 4, in use the hose drainer device 100 is positioned on a container lid 402 of a container 110 used to retain the liquid and other materials flushed from the hose 108. Typically, the hose drainer device 100 is placed on the container lid 402 and one end of a hose 108 is inserted into the notched through-hole 300 and secured by the lock component 302 to retain the hose 108 in place within the device 100. The hose end is then inserted into the pour spout (i.e., container opening 112) or another through-hole within the container lid 402. Once in place, the hose 108 can then be flushed from the other end of the hose 108, with the contents of the hose 108 being released into the container 110 safely and easily, without spills and/or messes. The hose 108 is removed and the pour spout 112 is then sealed, and the container 110 can be disposed of properly when finished. In another embodiment, the hose drainer device 100 can be releasably secured to the container lid 402 via a clamp 404 positioned on each base component 104, or the hose drainer device 100 can be secured via screws, nuts and bolts, straps, etc.

In one embodiment, the hose drainer device 100 is manufactured from wood, titanium, aluminum, steel, plastic, fiber-reinforced plastic, or other suitable materials as is known in the art, or a combination of such materials.

In yet another embodiment, the hose drainer device 100 comprises a plurality of indicia 400. The top plate component 102 of the device 100 may include advertising, a trademark, or other letters, designs, or characters, printed, painted, stamped, or integrated into the top plate component 102, or any other indicia 400 as is known in the art. Specifically, any suitable indicia 400 as is known in the art can be included, such as but not limited to, patterns, logos, emblems, images, symbols, designs, letters, words, characters, animals, advertisements, brands, etc., that may or may not be hose, drain, or brand related.

FIG. 5 illustrates a flowchart of the method of safely draining fluids from a hose. The method includes the steps of at 500, providing a hose drainer device comprising a top plate component supported by a base component and a pair of upright leg components. The method also comprises at 502, inserting a hose into a notch of the top plate component. Further, the method comprises at 504, securing the hose within the notch via the lock component. The method also comprises at 506, placing a container underneath the top plate component and beneath the hose. Finally, the method comprises at 508, draining the hose into the container and disposing of the contents properly when finished.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “hose drainer device”, “hose device”, “drainer device”, and “device” are interchangeable and refer to the hose drainer device 100 of the present invention.

Notwithstanding the forgoing, the hose drainer device 100 of the present invention can be of any suitable size and configuration as is known in the art without affecting the overall concept of the invention, provided that it accomplishes the above stated objectives. One of ordinary skill in the art will appreciate that the hose drainer device 100 as shown in FIGS. 1-5 is for illustrative purposes only, and that many other sizes and shapes of the hose drainer device 100 are well within the scope of the present disclosure. Although the dimensions of the hose drainer device 100 are important design parameters for user convenience, the hose drainer device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A hose drainer device that provides a user with a means for safely draining hoses without spills or messes, the hose drainer device comprising:
a top plate component;
a pair of leg components; and
a pair of base components;
wherein the pair of base components are secured to the pair of legs components;
wherein the pair of leg components are secured to the top plate component;
wherein a hose to be drained is inserted into the top plate component and secured;
wherein a container is positioned underneath the pair of base components;
wherein the hose is held in place by the hose drainer device and easily drains into the container without spills or messes; and
further wherein the container is disposed of when finished.

2. The hose drainer device of claim 1, wherein the hose drainer device is utilized with a conventional hose that contains petroleum, antifreeze, and other suitable fluids.

3. The hose drainer device of claim 2, wherein the conventional hose is a 2″ diameter hose.

4. The hose drainer device of claim 3, wherein the top plate component is configured in a rectangular shape, measuring approximately 2″×6×18″ in dimension.

5. The hose drainer device of claim 4, wherein the top plate component comprises a top surface, a bottom surface, opposing side walls, and opposing front and back walls.

6. The hose drainer device of claim 5, wherein the pair of upright leg components are approximately 2″×4×12″ in dimension.

7. The hose drainer device of claim 6, wherein the pair of leg components each comprise an interior surface, an exterior surface, opposing top and bottom sides, and opposing sidewalls.

8. The hose drainer device of claim 7, wherein the pair of leg components are configured in a rectangular configuration and secured to the opposing sidewalls of the top plate component, positioning the top plate component between the interior surface of the leg components, such that they are in an orthogonal orientation to each other.

9. The hose drainer device of claim 8, wherein the pair of base components are each configured in a rectangular shape and measures approximately 2″×8×18″.

10. The hose drainer device of claim 9, wherein the pair of base components each comprise a top surface, a bottom surface, opposing sidewalls, and opposing front and back walls.

11. The hose drainer device of claim 10, wherein the base components are approximately 12″ apart.

12. The hose drainer device of claim 11, wherein the pair of base components are laid flat on their bottom surfaces, and an upright leg component is screwed into the top surface of each base component, such that they are in an orthogonal orientation to each other.

13. The hose drainer device of claim 12, wherein the top plate component comprises a notched through-hole positioned in a center of the top plate component.

14. The hose drainer device of claim 13, wherein the top plate component comprises a lock component for securing the hose in the notched through-hole.

15. A hose drainer device that provides a user with a means for safely draining hoses without spills or messes, the hose drainer device comprising:
a top plate component comprising a top surface, a bottom surface, opposing side walls, and opposing front and back walls;
a pair of leg components each comprising an interior surface, an exterior surface, opposing top and bottom sides, and opposing sidewalls; and
a pair of base components each comprising a top surface, a bottom surface, opposing sidewalls, and opposing front and back walls; and
wherein the hose drainer device is utilized with a conventional hose that contains petroleum, antifreeze, and other suitable fluids;
wherein the pair of base components are laid flat on their bottom surfaces, and an upright leg component is screwed into the top surface of each base component, such that they are in an orthogonal orientation to each other;
wherein the pair of leg components are configured in a rectangular configuration and secured to the opposing sidewalls of the top plate component, positioning the top plate component between the interior surface of the leg components, such that they are in an orthogonal orientation to each other;
wherein the top plate component comprises a notched through-hole positioned in a center of the top plate component;
wherein a hose to be drained is inserted into the notched through-hole of the top plate component and secured via a lock component;
wherein a container is positioned underneath the pair of base components;
wherein the hose is held in place by the hose drainer device and easily drains into the container without spills or messes; and
further wherein the container is disposed of when finished.

16. The hose drainer device of claim 15, wherein the hose drainer device is positioned on a container lid of a container used to retain liquid and other materials flushed from the hose.

17. The hose drainer device of claim 15, wherein the hose drainer device is releasably secured to the container lid via a clamp positioned on each base component.

18. The hose drainer device of claim 15, wherein the lock component is a metal plate approximately 1/16″ thick, 1½″ wide, and 8″ long, positioned flat across a top of the notched through-hole on the top surface of the top plate component and is secured down by a first screw on one end and another end includes a notched end for accepting a second screw positioned on an opposing side of the notched through-hole.

19. The hose drainer device of claim 15 further comprising a plurality of indicia.

20. A method of safely draining fluids from a hose, the method comprising the following steps:
providing a hose drainer device comprising a top plate component supported by a base component and a pair of upright leg components;
inserting a hose into a notch of the top plate component;
securing the hose within the notch via the lock component;
placing a container underneath the top plate component and beneath the hose; and
draining the hose into the container and disposing of the contents properly when finished.
